(19) United States
(12) Patent Application Publication
(10) Pub. No.: US 2020/0239371 A1
(43) Pub. Date: Jul. 30, 2020

(54) SUBSTRATE INCLUDING POLYMER AND CERAMIC COLD-SINTERED MATERIAL

(71) Applicant: SABIC Global Technologies B.V., Bergen op Zoom (NL)

(72) Inventors: Neal PFEIFFENBERGER, Mt. Vernon, IN (US); Thomas L. EVANS, Mt. Vernon, IN (US); Clive RANDALL, Mt. Vernon, IN (US); Jing GUO, Mt. Vernon, IN (US)

(21) Appl. No.: 16/641,743

(22) PCT Filed: Aug. 24, 2018
(86) PCT No.: PCT/US2018/047942

§ 371 Date: Feb. 25, 2020

Related U.S. Application Data
(60) Provisional application No. 62/550,417, filed on Aug. 25, 2017.

(51) Int. Cl. C04B 35/634; C04B 35/01; C04B 35/64; H01G 4/20; C04B 41/00; C04B 41/45

(52) U.S. Cl. CPC C04B 35/634; C04B 35/01; C04B 35/64; C04B 2235/66; C04B 41/009; C04B 41/4505; H01G 4/206

(57) ABSTRACT

Various examples disclosed relate to a substrate. The substrate includes a cold-sintered hybrid material. The cold-sintered hybrid material includes a polymer component and a ceramic component. The substrate further includes a conductor at least partially embedded within the cold-sintered hybrid material. The substrate further includes a via attached to the conductor. The cold-sintered hybrid material has a relative density in a range of from about 80% to about 99%.

### CROSS-REFERENCE TO RELATED APPLICATION

This application claims the benefit of priority to U.S. Provisional Patent Application Ser. No. 62/550,417 entitled “SUBSTRATE INCLUDING POLYMER AND CERAMIC COLD-SINTERED MATERIAL,” filed Aug. 25, 2017, the disclosure of which is incorporated herein in its entirety by reference.

### BACKGROUND

High-frequency ceramic dielectric substrates can be limited in their ability to easily tune electrical properties (e.g., having a suitable dielectric constant, having a flat temperature coefficient of the resonant frequency or permittivity). Additionally, high-frequency ceramic dielectric substrates can lack high mechanical stability (resistance to cracking) and high thermal conductivity.

### SUMMARY OF THE DISCLOSURE

According to this disclosure, ceramic/polymer a composite material has been developed via a cold sintering process (CSP) as a substrate for application as a high-frequency device substrate in electronic applications that addresses the problems mentioned above. The composite substrate can be a single layer structure (e.g., metal, insulator, metal and/or metal, insulator) or a layered structure (e.g., encompassing multiple layers of metal, insulator, metal stacked upon one another, or insulators stacked upon one another). The substrate can operate as a low-temperature co-fired ceramic (LTCC) device. LTCC devices can have multiple functions due to the incorporation of resistors, inductors, capacitors, active components, dielectric resonators, and the like.

The disclosed ceramic/polymer structure can include several benefits, according to various examples. For example, the structure has the ability to have a tunable dielectric constant (which can be helpful for the miniaturization of antennas) as well as increased mechanical and electrical performance due to the polymer phase flowing (e.g., not remaining as a hard particle). These properties can help prevent the short failure mode, due to the incorporation of the polymer. The material also can be loaded with un-melted polymer for a greater Dk tunability. Matching of the coefficient of thermal expansion between that of the substrate and either the integrated devices or the metal electrodes is also possible with this design. In addition, according to various examples, the disclosed substrate can retain many of the unique features of ceramic capacitors over polymer film capacitors. The ceramic/polymer material structure can include the best properties of each material class for high-frequency substrate applications.

Another benefit, according to some examples, is the flexibility to alter the ceramic/polymer ratio of the composite material which can allow for targeting specific electrical property performances between a polymer and a ceramic constructed from the individual constituents.

Another benefit, according to some examples, is the ability to improve mechanical properties with the addition of a polymeric material. The presence of the polymer can address brittleness issues with LTCCs where cracks form, propagate, and result in electrical shorting/failure between layers. The failure of high-frequency substrates due to flexure is a problem that can potentially be improved using this polymer/ceramic hybrid system. Furthermore, according to some examples, durability and overall robustness of the high-frequency substrate can be improved in conjunction with its electrical performance. According to some examples, the hybrid system can also maintain its dielectric properties (e.g., capacitance change, IR, ESR, and the like) after compression/flexion compared to pure ceramic-based capacitors. According to further examples, the addition of a polymer can improve thermal shock resistance and can limit or prevent thermal stress cracking. This can occur because the polymer used in this disclosure assists in relieving stress during transient temperature swings in the application as well as in the production of a high-frequency substrate.

According to some examples, the ceramic/polymer material is capable of being made into tapes for commercial scale manufacturing. The materials can be made into discrete layers, which are stacked and co-fired to form the substrate. According to some examples, to make a composite material a cold sintering process (CSP) can include a low temperature sintering process to which polymeric materials can be introduced into the ceramic to make the composite material. The ability to cold-sinter allows for the formation of a substrate having a density of at least 85%. This would not be possible with a traditional ceramic-based capacitor since sintering temperatures to increase density (e.g., to at least 85% or greater than 90%) and obtain desired electrical properties are extremely high (e.g., greater than 400° C.) and exceed temperature limitations of polymeric materials. The traditional methods would cause the polymer to degrade or burn off. Thus, the examples presented herein can provide substrates having a composite/polymer structure and desired electrical and mechanical properties.

### BRIEF DESCRIPTION OF THE FIGURES

The drawings illustrate generally, by way of example, but not by way of limitation, various embodiments discussed in the present document.

FIG. 1 is a sectional view of a substrate including a cold-sintered hybrid material, in accordance with various embodiments.

FIG. 2 is a flow chart illustrating a method of forming the cold-sintered hybrid material, in accordance with various embodiments.

FIG. 3 is a graph showing a software analysis report of a cold-sintered hybrid material, in accordance with various embodiments.

FIG. 4 is a graph showing a coefficient of thermal expansion of a cold-sintered hybrid material, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section.

In the methods described herein, the acts can be carried out in any order without departing from the principles of the inventive subject matter, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “oligomer” as used herein refers to a molecule having an intermediate relative molecular mass, the structure of which essentially includes a small plurality of units derived, actually or conceptually, from molecules of lower relative molecular mass. A molecule having an intermediate relative mass can be a molecule that has properties that vary with the removal of one or a few of the units. The variation in the properties that results from the removal of the one of more units can be a significant variation.

The term “solvent” as used herein refers to a liquid that can dissolve a solid, liquid, or gas. Non-limiting examples of solvents are silicones, organic compounds, water, alcohols, ionic liquids, and supercritical fluids.

The term “thermoplastic polymer” as used herein refers to a polymer that has the property of converting to a fluid (flowable) state when heated and of becoming rigid (nonflowable) when cooled.

The polymers described herein can terminate in any suitable way. In some examples, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

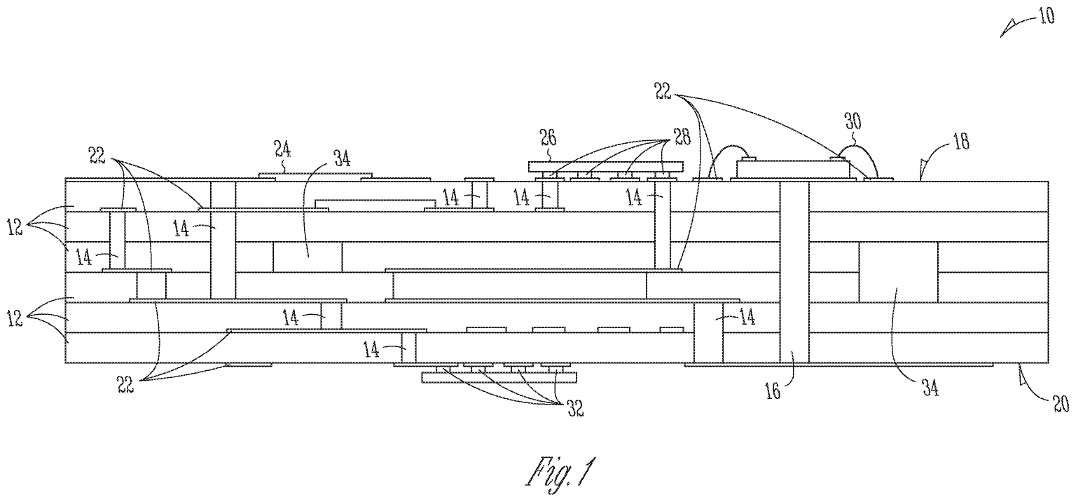

According to various examples, a substrate such as a low temperature co-fired ceramic substrate is disclosed. FIG. 1 is a schematic sectional view of substrate 10. As shown in FIG. 1, substrate 10 includes at least one layer 12 including a cold-sintered hybrid material, at least one via 14, at least one thermal via 16, first surface 18, opposite second surface 20, at least one conductive layer 22, at least one resistor 24, at least one silicon die 26, at least one solder ball 28, wires 30, pads 32, and cavity 34.

As shown in FIG. 1, substrate 10 includes six layers 12 of the cold-sintered hybrid material. While six layers are shown, it is possible for substrate 10 to include any suitable amount of layers 12. For example, substrate 10 can include one layer to 400 layers 12, two layers to 38 layers, 10 layers to 30 layers, 15 layers to 25 layers, five layers to about 300 layers, 50 layers to about 200 layers, or less than, equal to, or greater than one layer, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, or 400 layers 12. Each layer 12 can have any suitable thickness. For example, the thickness can be in a range of from about 10 μm to about 100 mm, about 50 μm to about 50 mm, about 70 μm to about 30 mm, about 90 μm to about 10 mm, or less than, equal to, or greater than 10 μm, 50 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 0.1 mm, 5 mm, 10 mm, 15 mm, 20 mm, 25 mm, 30 mm, 35 mm, 40 mm, 45 mm, or 50 mm. Individual layers 12 can be held together through a bond, or an adhesive material can be disposed between the layers 12.

Each of layers 12 includes a cold-sintered hybrid material. The cold-sintered hybrid material at least includes a polymer component and a ceramic component interspersed with respect to each other. The operation of cold sintering is discussed further herein. The polymer component can include one or more polymers, polymer particles, or a polymerizable mixture of monomers or oligomers. The polymer component can be in a range of from about 5 wt % to about 60 wt % of the cold-sintered hybrid material, about 10 wt % to about 55 wt %, about 15 wt % to about 50 wt %, about 20 wt % to about 45 wt %, about 25 wt % to about 40 wt %, about 30 wt % to about 35 wt %, or less than, equal to, or greater than about 5 wt %, 10, 15, 20, 25, 30, 35, 40, 45, 50, 55, or about 60 wt % of the cold-sintered hybrid material.

In one example, the polymer component can include a thermoplastic polymer, such as polypropylene. In another example, the polymer component can include a thermoset polymer, such as an epoxy or the like. In another example, the polymer component can include an amorphous polymer. In another example, the polymer component can include a semi-crystalline polymer. In another example, the polymer component can include a blend, such as a miscible or immiscible blend. In another example, the polymer component can include a homopolymer, a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, an ionic polymer, a non-ionic polymer, or a mixture thereof.

Some specific examples of acceptable polymers include, but are not limited to, polyethylene, polyester, acrylonitrile butadiene styrene (ABS), polycarbonate (PC), polyphenylene oxide (PPO), polybutylene terephthalate (PBT), isophthalate terephthalate (ITR), Nylon, HTN, polyphenyl sulfide (PPS), liquid crystal polymer (LCP), polyaryletherketone (PAEK), polyether ether ketone (PEEK), polyetherimide (PEI), polyimide (PI), fluoropolymers, PES, polysulfone (PSU), PPSU, SRP (Paramax™), PAI (Torlon™), and blends thereof.

In some examples, the polymer component can include one or more resins or oligomers that can be polymerized within a mold, such as an injection mold, or other tooling surface along with other components of the polymer component. In one example, the resin is flowable The one or more resins in the flowable resin can be any one or more curable resins, such as an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). The flowable resin composition can include polycarbonate (PC), acrylonitrile butadiene styrene (ABS), polybutylene terephthalate (PBT), polyethylene terephthalate (PET), polyetherimide (PEI), poly(p-phenylene oxide) (PPO), polyamide (PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), or a combination thereof. The flowable resin can be polycarbonate, polyacrylamide, or a combination thereof. A glass transition temperature of the polymer or reactive oligomer can be greater than 200° C.

In other examples, the polymer component can include a polymer that is formed from polymerization of monomers. Polymerization can occur through many suitable processes such as radical polymerization, ring-opening polymerization, thermal polymerization, or incorporation of reactive oligomers. Many monomers suitable for this purpose contain unsaturated homo or heteronuclear double bonds, dienes, trienes, and/or strained cycloaliphatics. Examples of monomers for use in radical polymerization reactions include acrylic acids, acrylamides, acrylic esters, esters of acrylic and methacrylic acids (e.g., n-butyl acrylate, 2-hydroxyethyl methacrylate), amides of acrylic and methacrylic acids (e.g., n-isopropyl acrylamide), acrylonitriles, methyl methacrylates, (meth)acrylates of polyhydric alcohols (e.g., ethylene glycol, trimethylolpropane), styrenes, styrene derivatives (e.g., 1,4 divinylbenzene, p-vinylbenzyl chloride, and p-acetoxy styrene), 4-vinyl pyridines, n-vinyl pyrrolidones, vinyl acetates, vinyl chlorides, vinyl fluorides, vinylidene fluorides, ethylene, propylene, butadiene, chloroprene, and vinyl ethers.

Radical polymerization can be initiated by the generation of primary radicals. Suitable initiators for this purpose include azo initiators (e.g., dialkyldiazenes, AIBN), peroxides (e.g., dicumylperoxide, persulfate, and ethylmethylketone peroxide), diphenyl compounds, photo-initiators (e.g., alpha-hydroxyketones, alpha-aminoketones, acylphosphine oxide, oxime esters, benzophenones, and thioxanthones), and silylated benzopinacols. In some examples, the ceramic component compound (e.g., ZnO₂) that participates in the cold sintering processes described herein can be photo-induced and thereby generate radicals for in situ polymerization.

Ring-opening polymerization methods can be desirable for polymerizing the monomers because they can produce polymers generally possessing low melt viscosities. The polymers also are readily soluble in organic solvents, combinations of organic solvents with water, and sometimes even water alone. Exemplary cyclic monomers for use in ring-opening polymerization, in accordance with the processes described herein, include cyclic ethers, cyclic amines, lactones, lactams, cyclic sulfides, cyclic siloxanes, cyclic phosphites and phosphonites, cyclic imino ethers, cyclic olefins, cyclic carbonates, and cyclic esters. Additional examples of cyclic monomers and oligomers include epoxides, cyclic phosphazenes, cyclic phosphonates, cyclic organosiloxanes, cyclic carbonate oligomers, and cyclic ester oligomers. Additional illustrative monomers are cyclic monomers that bear functional groups such as formals, thioformals, sulfides, disulfides, anhydrides, thiolactones, ureas, imides, and bicyclic monomers.

Still further examples of ring systems that are suitable include aromatic macrocyclic aromatic carbonate oligomers and macrocyclic polyalkylene carboxylate ester oligomers. When polymerized, these oligomers yield aromatic polycarbonates and polyesters.

Many cyclic monomers and oligomers are liquids at standard temperature and pressure, while others are low temperature melting solids to give low viscosity liquids under the same conditions. In these instances, according to various examples, such cyclic monomers and oligomers can be used neat (e.g., without dilution by a solvent) in the processes described herein. Polymers resulting from these monomers can vary widely in molecular weights depending upon polymerization conditions, such as catalyst loading and the presence and concentration of any chain-termination agents.

The polymerizability and rates of polymerization of cyclic monomers can be influenced both by ring size and by the sub stituents on the rings. In general, smaller ring sizes of three to five ring members or otherwise strained rings usually have high heats of polymerization due to ring strain and other factors. Larger rings can often be polymerized even with low heats of polymerization through entropy contributions.

Thermal polymerization methods can be suitable. Monomers that can be polymerized upon heating are those that typically have one or more carbon-carbon triple bonds (e.g., ethynyl and propargyl groups) and/or heteroatomic unsaturated bonds, such isocyanates, cyanates, and nitriles. In some examples, the rate of polymerization and resulting formation of a polymer composite can be controlled by adding polymerization accelerators that contain bi, tri- or multifunctional reactive groups, such as alkynyl groups.

Alternatively, ring strained aliphatic monomers (e.g., hydrocarbons) can be ring-opened by their exposure to sufficient external and capillary pressure. In addition, or alternatively, polymerization of monomers can be catalyzed by the particulate inorganic compound or by the cold-sintered ceramic. In some examples, the polymerization onset temperatures are higher than temperatures employed in the cold sintering steps; in these examples, the application of greater external pressure can substantially decrease the needed polymerization onset temperature.

Examples of monomers for use in thermal polymerization include cyanates, benzocylcobutenes, alkynes, phthalonitriles, nitriles, maleimides, biphenylenes, benzoxazines, norbornenes, cylic aliphatics, bridging cyclohydrocarbons, and cyclooctadienes.

In examples where the polymer component includes collection of monomers or oligomers, the polymer component can include any suitable polymerization aides for facilitating or modulating the polymerization reaction. For example, non-limiting examples can include polymerization catalysts and catalyst promoters, polymerization catalyst inhibitors, polymerization co-catalysts, photo initiators in combination with light sources, phase transfer catalysts, chain transfer agents, and polymerization accelerators. In some examples, these components are incorporated without dilution or dissolution into the mixture. In other examples, the components are partially or fully dissolved in the solvent that is used in the processes. Alternatively, the components can be coated onto the ceramic component, such as by first dissolving the components in a suitable solvent, contacting the resulting solution with the particles, and allowing (or causing) the solvent to evaporate and thereby yield coated ceramic particles.

In accordance with some examples, the polymerization processes described herein do not include a polymerization catalyst. This can be because an inorganic compound or the resulting cold-sintered ceramic acts as a polymerization catalyst, obviating the need to utilize an added catalyst. In other examples, an acid or base admixed with the solvent facilitates polymerization, such as by initiation, without the need for an added polymerization catalyst.

In some examples, one or more of the components described above are encapsulated. For example, a polymerization catalyst can be an encapsulated catalyst. The use of encapsulated catalysts allows the utilization of higher molecular reactants and use of heat during the cold sintering process without pre-cure of the reactants. For example, encapsulated catalysts prevent premature reaction of the various reactants during storage and processing and yet, upon the rupture of the capsules by a pre-determined event such as the application of heat, pressure, or solvation, produce rapid cure. The use of encapsulated catalysts is useful in some examples of the invention wherein cold-sintering and polymerization are performed substantially simultaneously.

The encapsulated catalysts can be produced by deposition of a shell around the catalyst. The catalyst can be contained in one single cavity or reservoir within the capsule or can be in numerous cavities within the capsule. The thickness of the shell can vary considerably depending on the materials used, loading level of catalyst, method of forming the capsule, and intended end-use. Loading levels of the catalyst range from about 5 to about 90%, from about 10% to about 90%, or from about 30% to about 90%. Certain encapsulation processes lend themselves to higher core volume loading than others. More than one shell can be desirable to ensure premature breakage or leaking. The encapsulated catalysts can be made by any of a variety of micro-encapsulation techniques including but not limited to coacervation, interfacial addition and condensation, emulsion polymerization, microfluidic polymerization, reverse micelle polymerization, air suspension, centrifugal extrusion, spray drying, prilling, and pan coating.

The cold-sintered hybrid material further includes a ceramic component that includes one or more ceramic particles. In one example, the ceramic particles include binary ceramics, such as molybdenum oxide (MoO₃). In other examples, the ceramic particles can include binary, ternary, or quaternary compounds chosen from families of oxides, fluorides, chlorides, iodides, carbonates, phosphates, glasses, vanadates, tungstates, molybdates, tellurates, or borates. One example of a ternary ceramic particle includes K₂Mo₂O₇. Although these example ceramic families are used as examples, the list is not exhaustive. Any ceramic that is capable of cold sintering as described in the present disclosure is within the scope of the inventive subject matter.

Selected examples of ceramic materials that are capable of cold sintering include, but are not limited to, BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, and Bi₄B₂O₉. Although individual ceramic materials are listed, the disclosure is not so limited. In selected examples, the ceramic component can include combinations of more than one ceramic material, including, but not limited to, the ceramic materials listed above.

The ceramic particles can be shaped as spheres, whiskers, rods, fibrils, fibers, or platelets. An average size of the individual particles along a largest dimension can be in a range of from about 20 nm to about 30 μm, about 5 μm to about 25 μm, about 10 μm to about 20 μm, or less than, equal to, or greater than about 20 nm, 19.5 nm, 19 nm, 18.5 nm, 18 nm, 17.5 nm, 17 nm, 16.5 nm, 16 nm, 15.5 nm, 15 nm, 14.5 nm, 14 nm, 13.5 nm, 13 nm, 12.5 nm, 12 nm, 11.5 nm, 11 nm, 10.5 nm, 10 nm, 9.5 nm, 9 nm, 8.5 nm, 8 nm, 7.5 nm, 7 nm, 6.5 nm, 6 nm, 5.5 nm, 5 nm, 4.5 nm, 4 nm, 3.5 nm, 3 nm, 2.5 nm, 2 nm, 1.5 nm, 1 nm, 0.5 nm, 0.5 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, 10.5 μm, 11 μm, 11.5 μm, 12 μm, 12.5 μm, 13 μm, 13.5 μm, 14 μm, 14.5 μm, 15 μm, 15.5 μm, 16 μm, 16.5 μm, 17 μm, 17.5 μm, 18 μm, 18.5 μm, 19 μm, 19.5 μm, 20 μm, 20.5 μm, 21 μm, 21.5 μm, 22 μm, 22.5 μm, 23 μm, 23.5 μm, 24 μm, 24.5 μm, 25 μm, 25.5 μm, 26 μm, 26.5 μm, 27 μm, 27.5 μm, 28 μm, 28.5 μm, 29 μm, 29.5 μm, or about 30 μm.

The ceramic component is in a range of from about 50 wt % to about 95 wt % of the cold-sintered hybrid material, about 55 wt % to about 90 wt %, about 60 wt % to about 85 wt %, about 60 wt % to about 75 wt %, about 65 wt % to about 80 wt %, about 70 wt % to about 75 wt %, less than, equal to, or greater than about 50 wt %, 55, 60, 65, 70, 75, 80, 85, 90, or about 95 wt % of the cold-sintered hybrid material. Relative to each other, a volume to volume ratio (v:v) of the polymer component and the ceramic component in each layer 12 of the hybrid cold-sintered material can be in a range of from about 1:100 to about 100:1, about 2:50 to about 50:2, or about 10:25 to about 25:10.

The cold-sintered hybrid material can include other components in addition to the polymer component and the ceramic component. For example, the cold-sintered hybrid material can include one or more fillers. The filler can be present in about 0.001 wt % to about 50 wt % of the cold-sintered hybrid material, or about 0.01 wt % to about 30 wt %, or less than, equal to, or greater than about 0.001 wt %, 0.01, 0.1, 1, 2, 3, 4, 5, 10, 15, 20, 25, 30, 35, 40, 45, or about 50 wt %. The filler can be homogeneously distributed in the material. The filler can be fibrous or particulate. The filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be talc, kenaf fiber, or combinations thereof. The filler can be coated with a layer of metallic material to facilitate conductivity, or surface treated with silanes, siloxanes, or a combination of silanes and siloxanes to improve adhesion and dispersion within the composite. The filler can be selected from carbon fibers, mineral fillers, and combinations thereof. The filler can be selected from mica, talc, clay, wollastonite, zinc sulfide, zinc oxide, carbon fibers, glass fibers, ceramic-coated graphite, titanium dioxide, or combinations thereof.

As shown in FIG. 1, conductive layer 22 is in contact with layers 12. In some examples, conductive layer 22 is located between adjacent layers 12. Alternatively, conductive layer 22 can be disposed on an outer surface of substrate 10 such as first surface 18 or second surface 20. Conductive layer 22 can include an electrically conductive material such as metal. The metal can range from about 50 wt % to about 100 wt % of conductive layer 22, about 60 wt % to about 90 wt %, about 70 wt % to about 80 wt %, or less than, equal to, or greater than about, 50 wt %, 55, 60, 65, 70, 75, 80, 85, 90, 95, or 100 wt % of conductive layer 22. Examples of suitable metals that can be included in conductive layer 22 can include copper, gold, silver, nickel, an alloy thereof, an alloy of platinum and gold, an alloy of palladium and silver, or a mixture thereof. Conductive layer 22 can be adapted to be a signal transmission conductor, a power conductor, or a ground conductor.

Conductive layers 22 are connected by vias 14, which extend in a direction substantially perpendicular to conductive layers 22. Vias 14 can conduct an electrical signal between adjacent conductive layers 22. Vias 14 can be made of the same material as conductive layers 22. In addition to vias 14, substrate 10 can include thermal via 16. Thermal via 16 is shown in FIG. 1 as extending between first surface 18 and second surface 20. Thermal via 16 can include any thermally conductive material, such as the metal of vias 14 or conductive layer 22. Thermal via 16 is adapted to conduct and transport heat from an interior of substrate 10 to an exterior of substrate 10 where the heat can be dissipated.

FIG. 1 further shows silicon dies 26. Silicon dies 26 can be chosen from a central processing unit, a flash memory, a wireless charger, a power management integrated circuit (PMIC), a Wi-Fi transmitter, and a global positioning system, an antenna, and a NAND stack. Silicon dies 26 are one example of a suitable electronic component that can be included in substrate 10. Other examples include resistor 24. Further examples of suitable electronic components include an inductor, a capacitor, an integrated circuit, a band-pass filter, a crystal oscillator, or an antenna. The electrical components can be electrically coupled to conductive layer 22 by solder balls 28 or wires 30.

The materials in the cold-sintered hybrid material can be selected to affect the properties of substrate 10. For example, different polymers or ceramics can be included to alter the dielectric constant of layer 12 to be better suited to accommodate an electrical component disposed therein. Altering the materials in the cold-sintered hybrid material can also help to tune the coefficient of thermal expansion to substantially match the coefficient of thermal expansion of the electrical components embedded therein.

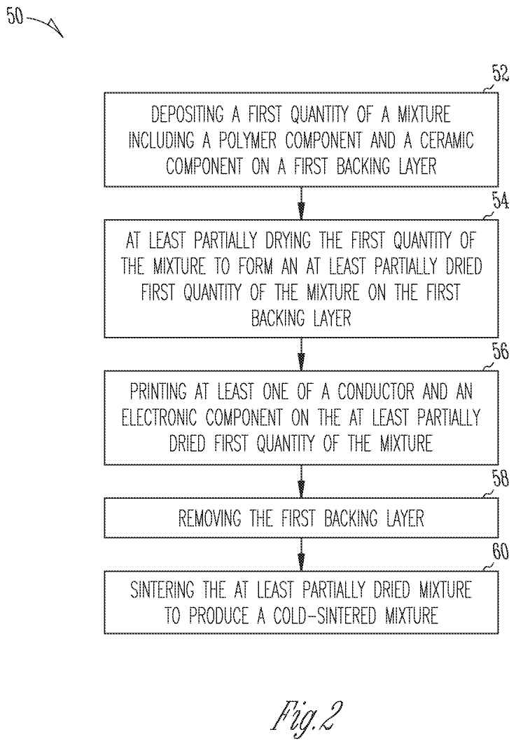

Substrate 10 can be made according to any suitable method. An example of a suitable method is shown in FIG. 2. FIG. 2 is a flow diagram of method 50 for forming substrate 10. Method 50 includes operation 52. In operation 52, a first quantity of a mixture including the polymer component, and the ceramic and binder components, is deposited on a first backing layer. The binder can be chosen from: polyvinyl alcohol, carboxyl group-modified polyvinyl alcohol, polyvinyl pyrrolidone, polyethylene oxide, polypropylene oxide, polyvinylidene fluoride, polyvinylidene fluoride-hexafluoropropylene copolymer, polyacrylic acid, lithium polyacrylate, poly(methyl methacrylate), poly(butyl acrylate), ethyl hydroxyethyl cellulose, styrene-butadiene resin, carboxymethyl cellulose, polyimide, polyacrylonitrile, polyurethane, ethyl-vinyl acetate copolymer and polyester. The backing layer can be a solid planar film that can include at least one polymer. In some examples, the polymer of the backing layer can be different than that of the polymer component. The backing can be at least partially coated with silicone.

At operation 54, the mixture is at least partially dried such that the mixture is at least partially solidified. The mixture can also be completely dried. Completely or partially drying the mixture can make it easier to process in further operations. The mixture can be dried simply by air drying, but the mixture can also be elevated above ambient temperatures to accelerate drying. After the mixture is dried, the backing can be cut. Cutting the backing produces at least two sheets of the mixture on the backing.

At operation 56, at least one of conductor 22, via 14, thermal via 16, or any other electrical component is printed on the at least partially dried mixture. Printing can include many different printing procedures. Examples of suitable printing procedures can include screen printing, deposition printing, aerosol printing, and ink-printing, or any combination thereof. In some examples the electrical components can also be formed through electrostatic coating methods such as electrolytic copper plating methods. In some examples, a hole can be formed in the mixture. A via can be formed in the hole, or an electrical component can be disposed at least partially therein.

At operation 58, the backing layer is removed from the mixture. In examples where the backing has been cut, the backing is removed from each sheet of the mixture. In examples where there are at least two sheets of the mixture, those sheets are stacked with respect to each other to form a substrate green structure.

The green structure is cold-sintered at operation 60. As the green structure is cold-sintered, the at least partially dried mixtures form respective layers of cold-sintered hybrid material. Cold-sintering generally includes raising a pressure in an environment surrounding the green structure and heating the green structure. The pressure can be raised in the environment surrounding the at least partially dried mixture to a range of from about 1 Mpa to about 5000 Mpa, about 200 Psi to about 3000 Psi, about 500 Psi to about 2000 Psi, or less than, equal to, or greater than about 1 Mpa, 100, 200, 300, 400, 500, 600, 700, 800, 900, 1000, 1100, 1120, 1130, 1140, 1150, 1160, 1170, 1180, 1190, 2000, 2100, 2200, 2300, 2400, 2500, 2600, 2700, 2800, 2900, 3000, 3100, 3200, 3300, 3340, 3350, 3360, 3370, 3380, 3390, 4000, 4100, 4200, 4300, 4400, 4500, 4600, 4700, 4800, 4900, or about 5000 Mpa.

After the pressure is raised, the substrate green structure can be contacted with a solvent. The processes of the inventive subject matter can employ at least one solvent in which the inorganic compound has at least partial solubility. Useful solvents include water, an alcohol such as a C(₁₋₆)-alkyl alcohol, an ester, a ketone, dipolar aprotic solvents (e.g., dimethylsulfoxide (DMSO), N-methyl-2-pyrrolidone (NMP), and dimethylformamide (DMF)), and combinations thereof. In some examples, only a single solvent is used. In other examples, mixtures of two or more solvents are used.

Still other examples provide for aqueous solvent systems to which one or more other components are added for adjusting pH. The components include inorganic and organic acids, and organic and inorganic bases.

Examples of suitable inorganic acids include sulfurous acid, sulfuric acid, hyposulfurous acid, persulfuric acid, pyrosulfuric acid, disulfurous acid, dithionous acid, tetrathionic acid, thiosulfurous acid, hydrosulfuric acid, peroxydisulfuric acid, perchloric acid, hydrochloric acid, hypochlorous acid, chlorous acid, chloric acid, hyponitrous acid, nitrous acid, nitric acid, pernitric acid, carbonous acid, carbonic acid, hypocarbonous acid, percarbonic acid, oxalic acid, acetic acid, phosphoric acid, phosphorous acid, hypophosphous acid, perphosphoric acid, hypophosphoric acid, pyrophosphoric acid, hydrophosphoric acid, hydrobromic acid, bromous acid, bromic acid, hypobromous acid, hypoiodous acid, iodous acid, iodic acid, periodic acid, hydroiodic acid, fluorous acid, fluoric acid, hypofluorous acid, perfluoric acid, hydrofluoric acid, chromic acid, chromous acid, hypochromous acid, perchromic acid, hydroselenic acid, selenic acid, selenous acid, hydronitric acid, boric acid, molybdic acid, perxenic acid, silicofluoric acid, telluric acid, tellurous acid, tungstic acid, xenic acid, citric acid, formic acid, pyroantimonic acid, permanganic acid, manganic acid, antimonic acid, antimonous acid, silicic acid, titanic acid, arsenic acid, pertechnetic acid, hydroarsenic acid, dichromic acid, tetraboric acid, metastannic acid, hypooxalous acid, ferricyanic acid, cyanic acid, silicous acid, hydrocyanic acid, thiocyanic acid, uranic acid, and diuranic acid.

Examples of suitable organic acids include malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, acetylsalicylic acid, acetic acid, and sulfonic acids such asp-toluene sulfonic acid.

Examples of suitable inorganic bases include aluminum hydroxide, ammonium hydroxide, arsenic hydroxide, barium hydroxide, beryllium hydroxide, bismuth(iii) hydroxide, boron hydroxide, cadmium hydroxide, calcium hydroxide, cerium(iii) hydroxide, cesium hydroxide, chromium(ii) hydroxide, chromium(iii) hydroxide, chromium(v) hydroxide, chromium(vi) hydroxide, cobalt(ii) hydroxide, cobalt(iii) hydroxide, copper(i) hydroxide, copper(ii) hydroxide, gallium(ii) hydroxide, gallium(iii) hydroxide, gold(i) hydroxide, gold(iii) hydroxide, indium(i) hydroxide, indium(ii) hydroxide, indium(iii) hydroxide, iridium(iii) hydroxide, iron(ii) hydroxide, iron(iii) hydroxide, lanthanum hydroxide, lead(ii) hydroxide, lead(iv) hydroxide, lithium hydroxide, magnesium hydroxide, manganese(ii) hydroxide, manganese(vii) hydroxide, mercury(i) hydroxide, mercury(ii) hydroxide, molybdenum hydroxide, neodymium hydroxide, nickel oxo-hydroxide, nickel(ii) hydroxide, nickel(iii) hydroxide, niobium hydroxide, osmium(iv) hydroxide, palladium(ii) hydroxide, palladium(iv) hydroxide, platinum(ii) hydroxide, platinum(iv) hydroxide, plutonium(iv) hydroxide, potassium hydroxide, radium hydroxide, rubidium hydroxide, ruthenium(iii) hydroxide, scandium hydroxide, silicon hydroxide, silver hydroxide, sodium hydroxide, strontium hydroxide, tantalum(v) hydroxide, technetium(ii) hydroxide, tetramethylammonium hydroxide, thallium(i) hydroxide, thallium(iii) hydroxide, thorium hydroxide, tin(ii) hydroxide, tin(iv) hydroxide, titanium(ii) hydroxide, titanium(iii) hydroxide, titanium(iv) hydroxide, tungsten(ii) hydroxide, uranyl hydroxide, vanadium(ii) hydroxide, vanadium(iii) hydroxide, vanadium(v) hydroxide, ytterbium hydroxide, yttrium hydroxide, zinc hydroxide, and zirconium hydroxide.

Organic bases typically are nitrogenous, as they can accept protons in aqueous media. Exemplary organic bases include primary, secondary, and tertiary (C₁₋₁₀)-alkylamines, such as methyl amine, trimethylamine, and the like. Additional examples are (C₆₋₁₀)-arylamines and (C₁₋₁₀)-alkyl-(C₆₋₁₀)-aryl-amines. Other organic bases incorporate nitrogen into cyclic structures, such as in mono- and bicyclic heterocyclic and heteroaryl compounds. These include, for instance, pyridine, imidazole, benzimidazole, histidine, and phosphazenes.

In some operations described herein, the ceramic component is combined with the solvent to obtain a mixture. According to various examples, the solvent is present in about 40% or less by weight, based upon the total weight of the mixture. Alternatively, the weight percentage of the solvent in the mixture is 35% or less, 30% or less, 25% or less, 20% or less, 15% or less, 10% or less, 5% or less, 3% or less, or 1% or less.

After the pressure is raised, the temperature of the green structure is raised. The degree to which the temperature is raised can differ depending on the selection of the polymer and ceramic materials. Generally, however, to be “cold-sintered”, the temperature is increased to a temperature sufficient to evaporate a quantity of the binder, but not greater than about 1° C. to about 200° C. above a boiling point of the solvent. As non-limiting examples, the green structure can be sintered at a temperature in a range of from about 100° C. to about 400° C., about 120° C. to about 300° C., about 150° C. to about 250° C., about 175° C. to about 200° C., or less than equal to, or greater than about 100° C., 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, or 400° C. The green structure can be heated for any suitable amount of time. After heating, the mixtures are cold-sintered and substrate 10 is formed.

In some examples, after cold-sintering, substrate 10 can be subjected to a variety of post-curing or finishing steps. These include, for instance, annealing and machining. An annealing step is introduced, in some examples, where greater physical strength or resistance to cracking is desired in the cold-sintered ceramic polymer composite. In addition, for some polymers or polymer combinations, the cold-sintering step, while sufficient to sinter the ceramic, does not provide enough heat to ensure complete flow of the polymer(s) into the ceramic voids. Hence, an annealing step can provide the heat for a time sufficient for complete flow to be achieved, and thereby ensure improved break-down strength, toughness, and tribological properties, for instance, in comparison to a cold-sintered ceramic polymer composite that did not undergo an annealing step.

Alternatively, the cold-sintered ceramic polymer composite can be subjected to optionally pre-programmed temperature and/or pressure ramps, holds, or cycles, wherein the temperature or pressure or both are increased or decreased, optionally multiple times.

The cold-sintered ceramic polymer composite also can be machined using conventional techniques known in the art. A machining step can be performed to yield finished parts. For instance, a pre-sintering step of injection molding can yield an overall shape of a part, whilst a post-sintering step of machining can add detail and precise features.

The cold-sintering steps of the processes can result in the densification of layer 12 of substrate 10. Thus, according to some examples, layer 12 exhibits a relative density of at least 70% as determined by mass/geometry ratio, the Archimedes method, or an equivalent method. The relative density can be in a range of from about 75% to about 99%, about, 80% to about 95%, about 85% to about 90%, or less than, equal to, or greater than about 75%, 80, 85, 90, 95, or 99%. The cold sintering can also give each layer 12 a degree of closed cell porosity, and the polymer component is dispersed within at least some of the closed cells of the sintered microstructure.

Briefly, the Archimedes method was employed to determine the density of samples using a KERN ABS-N/ABJ-NM balance equipped with an ACS-A03 density determination set. Dried samples (e.g., pellets) were first weighed (W_{dry}) and subjected to boiling in 2-propanol for a period of 1 h. The samples were then suspended in 2-propanol at a known temperature to determine the apparent mass in liquid (Wₛᵤₛ), removed, and the excess liquid wiped from the surface of the sample using a tissue moistened with 2-propanol. The saturated sample were then immediately weighed in air (Wₛₐₜ). The density is then determined by:

Density=W_{dry}/(Wₛₐₜ−Wₛᵤₛ)*density of solvent

where the density of 2-propanol was taken to be 0.786 g/cm³ at 20° C., 0.785 g/cm³ at 21° C., and 0.784 g/cm³ at 22° C.

The geometric method for determining density, also known as the “geometric (volume) method,” involves measuring the diameter (D) and thickness (t) of cylindrical samples using, e.g., a digital caliper. The volume of a cylinder can be calculated from the formula V=π(D/2)²×t. The mass of the cylindrical sample was measured with an analytical balance. The relative density was determined by dividing the mass by the volume.

The volume method is comparable to Archimedes method for simple geometries, such as cubes, cuboids and cylinders, in which it is relatively easy to measure the volume. For samples with highly irregular geometry, accurately measuring the volume may be difficult, in which case the Archimedes method may be more appropriate to measure density.

### EXAMPLES

Various embodiments of the present disclosure can be better understood by reference to the following Examples which are offered by way of illustration. The present disclosure is not limited to the Examples given herein.

### Example 1—Electrical Properties

In an example, a Na₂Mo₂O₇ powder was mixed with polyether imide (PEI) according to the following composition: (1-x)Na₂Mo₂O₇-xPEI (x=0, 10, 20, 30, 40, 50 Vol %). The mixture was ball-milled in ethanol for 24 hours, followed by drying at 85° C.

A (1-x)Na₂Mo₂O₇-xPEI (x=0, 10, 20 Vol %) and Ag electrode multilayer composite was fabricated by the cold sintered co-fired ceramic (CSCC) technology. At first, the (1-x)Na₂Mo₂O₇-xPEI powders were mixed with a solution of 95 wt % methylethylketone (MEK) and 5 wt % QPAC 40 resin (Empower Materials, Newark, Del., USA) and ball-milled for 12-24 h. Afterwards, another solution of 66.3 wt % methylethylketone (MEK), 28.4 wt % QPAC 40 resin, and 5.3 wt % butyl benzyl Phthalate S-160 (Tape Casting Warehouse, Morrisville, Pa., USA) was added into the slurry, followed by another ball-milling for 24 h and rolled for 1-2 h (MX-T6-S Analog Tube Roller, Scilogex, Rocky Hill, Conn., USA). Then, the (1-x)Na₂Mo₂O₇-xPEI green tapes were prepared by a tape casting procedure using a laboratory tape casting machine (A. J. Carsten Co., Inc, San Diego, Calif., USA) with a doctor blade casting head and a carrier film (silicone-coated polyethylene terephthalate). After drying at room temperature, the (1-x)Na₂Mo₂O₇-xPEI green tapes were cut into circles with one-inch diameter using CO₂ laser (Laser Systems, Scottsdale, Ariz., USA). Then some of (1-x)Na₂Mo₂O₇-xPEI tapes were printed with silver ink (DuPont 5029, Wilmington, Del., USA, or Metalon HPS-FG32, Austin, Tex., USA) using a screen printer (Model 645, AMI Presco, North Branch, N.J., USA). Afterwards, one (1-x)Na₂Mo₂O₇-xPEI layer with ring electrodes, six (1-x)Na₂Mo₂O₇-xPEI layers without electrodes and one (1-x)Na₂Mo₂O₇-xPEI layer with the whole electrode were stacked together, and laminated at 75° C. for 20 min with an isostatic pressure of 21 MPa (Isostatic Laminator, IL-4004 Pacific Trinetics Corporation, Carlsbad, Calif., USA). The binder burnout was performed at 200-240° C. for 2-3 hours with a heating rate of 0.5° C./min. Then, the (1-x)Na₂Mo₂O₇-xPEI-Ag multilayers were wetted by exposing to a water vapor in a sealed beaker at 60-75° C. Afterwards, the moistened layers were put into a die and cold sintered at 120° C. for 20 min (ramp time: 20-25 min) under uniaxial pressures of 175 MPa. Finally, all the cold sintered samples were dried in an oven at 120° C. for 6 hours.

The microstructures of cold-sintered samples were observed with an environmental scanning electron microscope (ESEM, FEI, Quanta 200) and a field emission scanning electron microscope (FESEM, FEI, NanoSEM 630). The permittivity and Q×f values of cold-sintered samples in the microwave range were measured according to the Hakki-Coleman resonant method using the TE₀₁₁ mode with a vector network analyzer (Anritsu 37369D). This is shown in Table 1 below. As shown in Table 1, a cold-sintered material of Na₂Mo₂O₇ and PEI from a bulk pellet, a cold-sintered tape casted 8-layer substrate including Na₂Mo₂O₇ and PEI, a cold-sintered Na₂Mo₂₀₇ material, and a cold-sintered Na₂Mo₂O₇ material and binder, were analyzed to determine their dielectric constant and electric at an applied frequency.

TABLE 1

| | Sintering | | | Applied | Layer |
|---|---|---|---|---|---|
| | Temper- | Dielectric | Electric | Fre- | Thick- |
| Sample | ature | Constant | Loss | quency | ness |
| Components | ° C. | (Eᵣ) | (Q) | (GHz) | (mm) |
| Na₂Mo₂O₇—PEI | 120 | 8.5 | 46 | 4.1 | 1.26 |
| (80 vol %:20 vol %) | | | | | |
| (bulk pellet) | | | | | |
| Na₂Mo₂O₇—PEI | 120 | 7.7 | 61 | 4.2 | 0.37 |
| (80 vol %:20 vol %) | | | | | |
| (Tape Casted- | | | | | |
| 8 layers) | | | | | |
| Na₂Mo₂O₇ | 120 | 12.7 | 50 | 3.4 | 2.2 |
| Na₂Mo₂O₇ and | 120 | 11.1 | 56 | 3.5 | 0.36 |
| binder | | | | | |

### Example 2—Coefficient of Thermal Expansion

The coefficient of thermal expansion for cold-sintered hybrid materials was measured using a TA instruments thermal mechanical analyzer TMA Q400 and the data is analyzed using Universal Analysis V4.5A from TA instruments.

Samples were re-shaped to form 13 mm round diameter, 2 mm thickness pellets to fit the TMA Q400 equipment. The sample, once placed in the TMA Q400, was heated to 150° C. (@20° C./min) at which point the moisture and stress was relieved and then cooled to −80° C. (@20° C./min) to start the actual coefficient of thermal expansion measurement. The sample was heated from −80° C. to 150° C. at 5° C. per minute at which the displacement is measured over temperature.

The measurement data was then loaded into the analysis software and the coefficient of thermal expansion was calculated using the Alpha x1-x2 method. The method measured the dimension change from temperature T1 to temperature T2 and transforms the dimension change to a coefficient of thermal expansion value with the following equation:

$$CTE ( µ m \text{/} ( m * ° C . ) ) = \frac{Δ L}{Δ T * L 0} \qquad Equation 1$$

Where:
ΔL=change in length (μm)
ΔT=change in temperature (° C.)
L0=sample length (m)

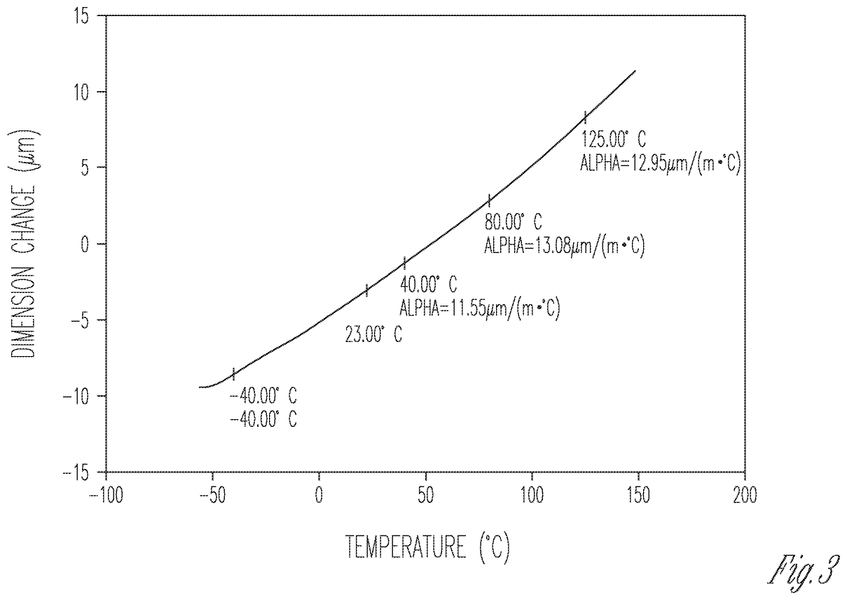

FIG. 3 shows an example of the analysis software report

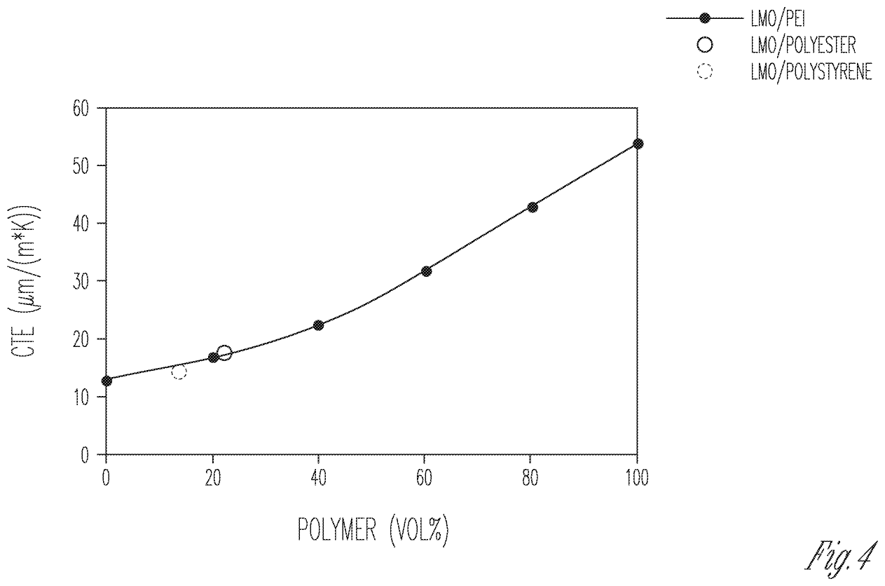

The coefficient of thermal expansion of three polymers, including polyether imide (PEI), polystyrene (PS) and polyester, each in Lithium Molybdate (LMO) cold sintered samples, in varying levels, were tested with the TMA Q400. The results can be found in Table 2 and FIG. 4.

TABLE 2
coefficient of thermal expansion of LMO/PEI, LMO/PS and
LMO/polyester cold sintered composites

| | CTE (μm/(m*K)) | | |
|---|---|---|---|
| | −40° C. | 23° C. | −40° C. |
| Sample | to 40° C. | to 80° C. | to 125° C. |
| Neat LMO | 11.6 | 13.1 | 13 |
| LMO/20 vol % PEI | 14.5 | 16.9 | 15.3 |
| LMO/40 vol % PEI | 19.9 | 22.4 | 22.1 |
| LMO/60 vol % PEI | 28.4 | 31.9 | 30.7 |
| LMO/80 vol % PEI | 38.1 | 43.1 | 41.1 |
| 100% PEI (datasheet | 54 | 54 | 54 |
| value −20° C. | | | |
| to 150° C) | | | |
| LMO/5 wt % | 12 | 14.3 | NA |
| (13.8 vol %) | | | |
| Polystyrene powder | | | |
| LMO/10 wt % | 15.9 | 17.6 | 16.9 |
| (22.3 vol %) | | | |
| Polyester powder | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed can be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a substrate comprising:

a cold-sintered hybrid material comprising:
a polymer component; and
a ceramic component;

a conductor at least partially embedded within the cold-sintered hybrid material; and

a via attached to the conductor,

wherein the cold-sintered hybrid material has a relative density in a range of from about 80% to about 99%.

Embodiment 2 provides the substrate of Embodiment 1, wherein the polymer component is chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C., a copolymer thereof, or a mixture thereof.

Embodiment 3 provides the substrate of any one of Embodiments 1 or 2, wherein the polymer component is a polymer formed from polymerization of one or more monomers or reactive oligomers.

Embodiment 4 provides the substrate of Embodiment 3, wherein the one or more monomers or reactive oligomers are chosen from a styrene, a styrene derivative, 4-vinylpyridine, an N-vinylpryrolidone, an acrylonitrile, a vinylacetate, an alkylolefin, a vinylether, a vinylacetate, a cyclic olefin, a maleimide, a cycloaliphatic, an alkene, or an alkyne, or a mixture thereof.

Embodiment 5 provides the substrate of any one of Embodiments 1-4, wherein the polymer component is chosen from a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof.

Embodiment 6 provides the substrate of any one of Embodiments 1-5, wherein the polymer component is in a range of from about 5 wt % to about 60 wt % of the cold-sintered hybrid material.

Embodiment 7 provides the substrate of any one of Embodiments 1-6, wherein the polymer component is in a range of from about 20 wt % to about 40 wt % of the cold-sintered hybrid material.

Embodiment 8 provides the substrate of any one of Embodiments 1-7, wherein the ceramic component includes one or more ceramic particles.

Embodiment 9 provides the substrate of Embodiment 8, wherein the one or more ceramic particles are shaped as spheres, whiskers, rods, fibrils, fibers, or platelets.

Embodiment 10 provides the substrate of any one of clams 8 or 9, wherein the one or more ceramic particles are chosen from oxides, fluorides, chlorides, iodides, carbonates, phosphates, glasses, vanadates, tungstates, molybdates, tellurates, borates or a mixture thereof.

Embodiment 11 provides the substrate of any one of Embodiments 8-10, wherein the one or more ceramic particles are chosen from BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈B₁₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉, or a mixture thereof.

Embodiment 12 provides the substrate of any one of Embodiments 8-11, wherein an average size of the individual particles of the one or more ceramic particles along a largest dimension is in a range of from about 20 nm μm to about 30 μm.

Embodiment 13 provides the substrate of any one of Embodiments 1-12, wherein the ceramic component is in a range of from about 50 wt % to about 95 wt % of the cold-sintered hybrid material.

Embodiment 14 provides the substrate of any one of Embodiments 1-13, wherein the ceramic component is in a range of from about 60 wt % to about 75 wt % of the cold-sintered hybrid material.

Embodiment 15 provides the substrate of any one of Embodiments 1-14, wherein a volume-to-volume ratio (v:v) of the polymer component and the ceramic component is in a range of from about 1:100 to about 100:1.

Embodiment 16 provides the substrate of any one of Embodiments 1-15, further comprising an adhesive disposed on the cold-sintered hybrid material.

Embodiment 17 provides the substrate of any one of Embodiments 1-16, wherein the cold-sintered hybrid material has a sintered microstructure that includes a degree of closed cell porosity, and the polymer component is dispersed within at least some of the closed cells of the sintered microstructure.

Embodiment 18 provides the substrate of any one of Embodiments 1-17, wherein a thickness of the cold-sintered hybrid material is in a range of from about 0.5 μm to about 100 mm.

Embodiment 19 provides the substrate of any one of Embodiments 1-18, wherein a thickness of the cold-sintered hybrid material is in a range of from about 0.5 mm to about 50 mm.

Embodiment 20 provides the substrate of any one of Embodiments 1-19, wherein the substrate comprises a plurality of layers of the cold-sintered hybrid material.

Embodiment 21 provides the substrate of Embodiment 20, wherein the plurality of layers of the cold-sintered hybrid material comprises from about 2 layers to about 400 layers.

Embodiment 22 provides the substrate of any one of Embodiments 1-21, wherein the relative density is in range of from about 90% to about 95%.

Embodiment 23 provides the substrate of any one of Embodiments 1-22, wherein the conductor comprises a metal.

Embodiment 24 provides the substrate of Embodiment 23, wherein the metal is chosen from copper, gold, silver, nickel, an alloy thereof, an alloy of platinum and gold, an alloy of palladium and silver, or a mixture thereof.

Embodiment 25 provides the substrate of any one of Embodiments 1-24, wherein the conductor is a conductive layer disposed between adjacent layers of the cold sintered hybrid material.

Embodiment 26 provides the substrate of any one of Embodiments 1-25, wherein the via comprises a metal.

Embodiment 27 provides the substrate of Embodiment 26, wherein the metal is chosen from copper, gold, silver, nickel, an alloy thereof, an alloy of platinum and gold, an alloy of palladium and silver, or a mixture thereof.

Embodiment 28 provides the substrate of any one of Embodiments 1-27, wherein the via extends from the conductor in a substantially perpendicular direction.

Embodiment 29 provides the substrate of any one of Embodiments 1-28, wherein the via extends between adjacent conductors.

Embodiment 30 provides the substrate of any one of Embodiments 1-29, further comprising a thermal via extending between a first surface of the substrate to a second surface of the substrate opposite the first surface.

Embodiment 31 provides the substrate of any one of Embodiments 1-30, wherein the conductor is chosen from a signal transmission conductor, a power conductor, or a ground conductor.

Embodiment 32 provides the substrate of any one of Embodiments 1-31, further comprising at least one of a first electronic component and a second electronic component attached to the conductor.

Embodiment 33 provides the substrate of Embodiment 32, wherein at least one of the first electronic component and the second electronic component is at least partially embedded within the substrate.

Embodiment 34 provides the substrate of any one of Embodiments 32 or 33, wherein at least one of the first and second electronic components are an inductor, a capacitor, a resistor, a silicon die, an integrated circuit, a band-pass filter, a crystal oscillator, or an antenna.

Embodiment 35 provides the substrate of Embodiment 34, wherein the silicon die is chosen from a central processing unit, a flash memory, a wireless charger, a power management integrated circuit (PMIC), a Wi-Fi transmitter, a global positioning system, and a NAND stack.

Embodiment 36 provides the substrate of any one of Embodiments 1-35, wherein a coefficient of thermal expansion of substrate including the cold-sintered hybrid material is greater than a corresponding substrate that is free of the cold-sintered hybrid material or includes a cold-sintered hybrid material having less of the polymer component.

Embodiment 37 provides a method of making a substrate, the method comprising:
depositing a first quantity of a mixture on a first backing layer, the mixture comprising:

a polymer component;

a ceramic component; and

a binder;

at least partially drying the first quantity of the mixture to form an at least partially dried first quantity of the mixture on the first backing layer;

removing the first backing layer;

printing at least one of a conductor and an electronic component on the at least partially dried first quantity of the mixture;

contacting the at least partially dried first quantity of the mixture with a solvent; and

sintering the at least partially dried first quantity of the mixture to produce a cold-sintered mixture, wherein sintering comprises:

raising a pressure in an environment surrounding the at least partially dried first quantity of the mixture to a range of from about 1 MPa to about 5000 Mpa;

raising a temperature of the at least partially dried first quantity of the mixture in a range of from about 1° C. to about 200° C. above a boiling point of the solvent to cold-sinter the at least partially dried first quantity of the mixture and produce the substrate, wherein the cold-sintered mixture has a relative density in a range of from about 80% to about 99%.

Embodiment 38 provides the method of Embodiment 37, further comprising increasing the temperature of the mixture to a temperature sufficient to evaporate a quantity of the binder.

Embodiment 39 provides the method of any one of Embodiments 37 or 38, further comprising:

cutting the first backing layer to produce a first portion of the mixture and a second portion of the mixture; and

stacking the first portion with respect to the second portion to form a stack, wherein the first portion forms a first cold-sintered hybrid layer and the second portion forms a second cold-sintered hybrid layer after sintering the stack.

Embodiment 40 provides the method of Embodiment 39, further comprising forming at least one hole in at least one of the first cold-sintered hybrid layer and the second cold-sintered hybrid layer.

Embodiment 41 provides the method of Embodiment 40, further comprising plating a metal on the surface of the cold-sintered hybrid layer defining the hole.

Embodiment 42 provides the method of Embodiment 40, further comprising disposing at least one electrical component at least partially within the hole.

Embodiment 43 provides the method of any one of Embodiments 37-42, wherein the at least partially dried first quantity of the mixture is sintered at a temperature in a range of from about 100° C. to about 400° C.

Embodiment 44 provides the method of any one of Embodiments 37-43, wherein the at least partially dried first quantity of the mixture is sintered at a temperature in a range of from about 120° C. to about 300° C.

Embodiment 45 provides the method of any one of Embodiments 37-44, wherein the pressure is in a range of from about 200 Psi to about 3000 Psi.

Embodiment 46 provides the method of any one of Embodiments 37-45, wherein the pressure is in a range of from about 500 Psi to about 2000 Psi.

Embodiment 47 provides the method of any one of Embodiments 37-46, wherein the pressure is in a range of from about 700 Psi to about 1000 Psi.

Embodiment 48 provides the method of any one of Embodiments 37-47, wherein the first backing layer comprises solid film comprising at least one polymer different than that of the polymer component.

Embodiment 49 provides the method of Embodiment 48, wherein a material is at least partially coated with silicone.

Embodiment 50 provides the method of any one of Embodiments 37-49, wherein the first backing layer is substantially planar.

Embodiment 51 provides the method of any one of Embodiments 37-50, wherein the polymer component is chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C. a copolymer thereof, or a mixture thereof.

Embodiment 52 provides the method of any one of Embodiments 37-51, wherein the polymer component is a polymer formed from the polymerization of one or more monomers or reactive oligomers.

Embodiment 53 provides the method of Embodiment 52, wherein the one or more monomers or reactive oligomers are chosen from a styrene, a styrene derivative, 4-vinylpyridine, an N-vinylpryrolidone, an acrylonitrile, a vinylacetate, an alkylolefin, a vinylether, a vinylacetate, a cyclic olefin, a maleimide, a cycloaliphatic, an alkene, an alkyne, or a mixture thereof.

Embodiment 54 provides the method of any one of Embodiments 52 or 53, wherein the polymer is chosen from a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof.

Embodiment 55 provides the method of any one of Embodiments 52-54, wherein the polymer component is in a range of from about 5 wt % to about 60 wt % of the cold-sintered mixture.

Embodiment 56 provides the method of any one of Embodiments 52-55, wherein the polymer component is in a range of from about 10 wt % to about 20 wt % of the cold-sintered mixture.

Embodiment 57 provides the method of any one of Embodiments 37-56, wherein the ceramic component includes one or more ceramic particles.

Embodiment 58 provides the method of Embodiment 57, wherein the one or more ceramic particles are shaped as at least one of spheres, whiskers, rods, fibrils, fibers, and platelets.

Embodiment 59 provides the method of any one of clams 57 or 58, wherein the one or more ceramic particles are chosen from oxides, fluorides, chlorides, iodides, carbonates, phosphates, glasses, vanadates, tungstates, molybdates, tellurates, boratesor a mixture thereof.

Embodiment 60 provides the method of any one of Embodiments 57-59, wherein the one or more ceramic particles are chosen from BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉, or a mixture thereof.

Embodiment 61 provides the method of any one of Embodiments 57-60, wherein an average size of the individual ceramic particles according to a largest dimension is in a range of from about 20 nm to about 30 μm.

Embodiment 62 provides the method of any one of Embodiments 37-61, wherein the ceramic component is in a range of from about 50 wt % to about 99 wt % of the mixture.

Embodiment 63 provides the method of any one of Embodiments 37-62, wherein the ceramic component is in a range of from about 80 wt % to about 90 wt % of the mixture.

Embodiment 64 provides the method of any one of Embodiments 37-63, wherein a volume-to-volume ratio (v:v) of the polymer component and the ceramic component in the mixture is in a range of from about 1:100 to about 100:1.

Embodiment 65 provides the method of any one of Embodiments 37-64, wherein at least one of the first cold-sintered hybrid layer and the second cold-sintered hybrid layer has a sintered microstructure that includes a degree of closed cell porosity, and the polymer component is dispersed within at least some of the closed cells of the sintered microstructure.

Embodiment 66 provides the method of any one of Embodiments 37-65, wherein a thickness of the first cold-sintered hybrid layer and the second cold-sintered hybrid layer is in a range of from about 10 μm to about 50 mm.

Embodiment 67 provides the method of any one of Embodiments 37-66, wherein a thickness of the first cold-sintered hybrid layer and the second cold-sintered hybrid layer is in a range of from about 0.5 mm to about 100 mm.

Embodiment 68 provides the method of any one of Embodiments 37-67, wherein the solvent is added to the at least partially dried first quantity of the mixture after the pressure is raised.

Embodiment 69 provides the method of Embodiment 68, wherein the solvent is chosen from water, an alcohol, an ether, a ketone, a dipolar aprotic solvent, or a mixture thereof.

Embodiment 70 provides the method of Embodiment 69, wherein the solvent further comprises an inorganic acid, an organic acid, an inorganic base, organic base, or a mixture thereof.

Embodiment 71 provides the method of any one of Embodiments 37-70, further comprising subjecting at least one of the first cold-sintered hybrid layer and the second cold-sintered hybrid layer to a post-curing or finishing step.

Embodiment 72 provides the method of any one of Embodiments 37-71, wherein printing comprises at least one of screen printing, deposition, aerosol printing, and ink-printing.

Embodiment 73 provides the method of any one of Embodiments 37-72, wherein the relative density is in a range of from about 90% to about 95%.

Embodiment 74 provides the method of any one of Embodiments 37-71, further comprising:

depositing a second quantity of the mixture on a second backing layer;

at least partially drying the second quantity of the mixture on the second backing layer to produce an at least partially dried second quantity of the mixture;

removing the second backing layer;

printing at least one of a conductor and an electronic component on the at least partially dried second quantity of the mixture; and

contacting the at least partially dried first quantity of the mixture with the at least partially dried second quantity of the mixture to form a stack.

Embodiment 75 provides a substrate formed according to a method comprising:

depositing a first quantity of a mixture on a first backing layer, the mixture comprising:
a polymer component;
a ceramic component; and
a binder;

at least partially drying the first quantity of the mixture to form an at least partially dried first quantity of the mixture on the first backing layer;

removing the first backing layer;

printing at least one of a conductor and an electronic component on the at least partially dried first quantity of the mixture;

contacting the at least partially dried first quantity of the mixture with a solvent; and

sintering the at least partially dried first quantity of the mixture, wherein sintering comprises:

raising a pressure in an environment surrounding the at least partially dried mixture to a range of from about 1 MPa to about 5000 Mpa;

raising a temperature of the at least partially dried mixture in a range of from about 1° C. to about 200° C. above a boiling point of the solvent to cold-sinter the at least partially dried mixture and produce the substrate, wherein

the cold-sintered mixture has a relative density in a range of from about 80% to about 99%.

Embodiment 76 provides the substrate of Embodiment 75, the method further comprising increasing the temperature of the mixture to a temperature sufficient to evaporate a quantity of the binder.

Embodiment 77 provides the substrate of any one of Embodiments 75 or 76, the method further comprising:

cutting the first backing layer to produce a first portion of the mixture and a second portion of the mixture; and

stacking the first portion with respect to the second portion to form a stack, wherein

the first portion forms a first cold-sintered hybrid layer and the second portion forms a second cold-sintered hybrid layer after sintering the stack.

Embodiment 78 provides the substrate of Embodiment 77, the method further comprising forming at least one hole in at least one of the first cold-sintered hybrid layer and the second cold-sintered hybrid layer.

Embodiment 79 provides the substrate of Embodiment 78, the method further comprising plating a metal on the surface of the cold-sintered hybrid layer defining the hole.

Embodiment 80 provides the substrate of Embodiment 78, the method further comprising disposing at least one electrical component at least partially within the hole.

Embodiment 81 provides the substrate of any one of Embodiments 75-80, wherein the at least partially dried first quantity of the mixture is sintered at a temperature in a range of from about 100° C. to about 400° C.

Embodiment 82 provides the substrate of any one of Embodiments 75-81, wherein the at least partially dried first quantity of the mixture is sintered at a temperature in a range of from about 120° C. to about 300° C.

Embodiment 83 provides the substrate of any one of Embodiments 75-82, wherein the pressure is in a range of from about 200 Psi to about 3000 Psi.

Embodiment 84 provides the substrate of any one of Embodiments 75-83, wherein the pressure is in a range of from about 500 Psi to about 2000 Psi.

Embodiment 85 provides the substrate of any one of Embodiments 75-84, wherein the pressure is in a range of from about 700 Psi to about 1000 Psi.

Embodiment 86 provides the substrate of any one of Embodiments 75-85, wherein the first backing layer comprises a solid film comprising at least one polymer different than that of the polymer component.

Embodiment 87 provides the substrate of Embodiment 86, wherein the material is at least partially coated with silicone.

Embodiment 88 provides the substrate of any one of Embodiments 75-87, wherein the first backing layer is substantially planar.

Embodiment 89 provides the substrate of any one of Embodiments 75-88, wherein the polymer component is chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C. a copolymer thereof, or a mixture thereof.

Embodiment 90 provides the substrate of any one of Embodiments 75-89, wherein the polymer component is a polymer formed from the polymerization of one or more monomers or reactive oligomers.

Embodiment 91 provides the substrate of Embodiment 90, wherein the one or more monomers or reactive oligomers are chosen from a styrene, a styrene derivative, 4-vinylpyridine, an N-vinylpryrolidone, an acrylonitrile, a vinylacetate, an alkylolefin, a vinylether, a vinylacetate, a cyclic olefin, a maleimide, a cycloaliphatic, an alkene, an alkyne, or a mixture thereof.

Embodiment 92 provides the substrate of any one of Embodiments 90 or 91, wherein the polymer is chosen from a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof.

Embodiment 93 provides the substrate of any one of Embodiments 90-92, wherein the polymer component is in a range of from about 5 wt % to about 60 wt % of the first cold-sintered mixture.

Embodiment 94 provides the substrate of any one of Embodiments 90-93, wherein the polymer component is in a range of from about 10 wt % to about 20 wt % of the first cold-sintered mixture.

Embodiment 95 provides the substrate of any one of Embodiments 75-94, wherein the ceramic component includes one or more ceramic particles.

Embodiment 96 provides the substrate of Embodiment 95, wherein the one or more ceramic particles are shaped as at least one of spheres, whiskers, rods, fibrils, fibers, and platelets.

Embodiment 97 provides the substrate of any one of clams 95 or 96, wherein the one or more ceramic particles are chosen from oxides, fluorides, chlorides, iodides, carbonates, phosphates, glasses, vanadates, tungstates, molybdates, tellurates, boratesor a mixture thereof.

Embodiment 98 provides the substrate of any one of Embodiments 95-97, wherein the one or more ceramic particles are chosen from BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂₋₃₂ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉, or a mixture thereof.

Embodiment 99 provides the substrate of any one of Embodiments 95-98, wherein an average size of the individual ceramic particles according to a largest dimension is in a range of from about 20 nm to about 30 μm.

Embodiment 100 provides the substrate of any one of Embodiments 75-99, wherein the ceramic component is in a range of from about 50 wt % to about 99 wt % of the mixture.

Embodiment 101 provides the substrate of any one of Embodiments 75-100, wherein the ceramic component is in a range of from about 80 wt % to about 90 wt % of the mixture.

Embodiment 102 provides the substrate of any one of Embodiments 75-101, wherein a volume-to-volume ratio (v:v) of the polymer component and the ceramic component in the mixture is in a range of from about 1:100 to about 100:1.

Embodiment 103 provides the substrate of any one of Embodiments 77-102, wherein at least one of the first cold-sintered hybrid layer and the second cold-sintered hybrid layer has a sintered microstructure that includes a degree of closed cell porosity, and the polymer component is dispersed within at least some of the closed cells of the sintered microstructure.

Embodiment 104 provides the substrate of any one of Embodiments 77-103, wherein a thickness of the first cold-sintered hybrid layer and the second cold-sintered hybrid layer is in a range of from about 10 μm to about 50 mm.

Embodiment 105 provides the substrate of any one of Embodiments 77-104, wherein a thickness of the first cold-sintered hybrid layer and the second cold-sintered hybrid layer is in a range of from about 0.5 mm to about 100 mm.

Embodiment 106 provides the substrate of any one of Embodiments 75-105, wherein the solvent is added to the at least partially dried first quantity of the mixture after the pressure is raised.

Embodiment 107 provides the substrate of Embodiment 106, wherein the solvent is chosen from water, an alcohol, an ether, a ketone, a dipolar aprotic solvent, or a mixture thereof.

Embodiment 108 provides the substrate of Embodiment 107, wherein the solvent further comprises an inorganic acid, an organic acid, an inorganic base, organic base, or a mixture thereof.

Embodiment 109 provides the substrate of any one of Embodiments 77-108, further comprising subjecting at least one of the first cold-sintered hybrid layer and the second cold-sintered hybrid layer to a post-curing or finishing step.

Embodiment 110 provides the substrate of any one of Embodiments 75-109, wherein printing comprises at least one of screen printing, deposition, aerosol printing, and ink-printing.

Embodiment 111 provides the substrate of any one of Embodiments 75-110, wherein the relative density is in a range of from about 90% to about 95%.

Embodiment 112 provides the substrate of any one of Embodiments 75-111, further comprising:

depositing a second quantity of the mixture on a second backing layer;

at least partially drying the second quantity of the mixture on the second backing layer;

removing the second backing layer;

printing at least one of a conductor and an electronic component on the at least partially dried second quantity of the mixture; and

contacting the at least partially dried first quantity of the mixture with the at least partially dried second quantity of the mixture to form a stack.

1. A substrate comprising:
a cold-sintered hybrid material comprising a mixture of:
a polymer component; and
a ceramic component;
a conductor at least partially embedded within the cold-sintered hybrid material; and
a via attached to the conductor,
wherein the cold-sintered hybrid material has a relative density within a range of 80% to 99%.

2. The substrate of claim 1, wherein the polymer component is chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C., a copolymer thereof, or a mixture thereof.

3. The substrate of any one of claim 1 or 2, wherein the polymer component is chosen from a branched polymer, a polymer blend, a copolymer, a random copolymer, a block copolymer, a cross-linked polymer, a blend of a cross-linked polymer with a non-crosslinked polymer, a macrocycle, a supramolecular structure, a polymeric ionomer, a dynamic cross-linked polymer, a liquid-crystal polymer, a sol-gel, or a mixture thereof.

4. The substrate of any one of claims 1-3, wherein the polymer component is in a range of from about 5 wt % to about 60 wt % of the cold-sintered hybrid material.

5. The substrate of any one of claims 1-4, wherein the polymer component is in a range of from about 20 wt % to about 40 wt % of the cold-sintered hybrid material.

6. The substrate of any one of claims 1-5, wherein the ceramic component includes one or more ceramic particles.

7. The substrate of claim 6, wherein the one or more ceramic particles are shaped as spheres, whiskers, rods, fibrils, fibers, or platelets.

8. The substrate of any one of clams 6 or 7, wherein the one or more ceramic particles are chosen from oxides, fluorides, chlorides, iodides, carbonates, phosphates, glasses, vanadates, tungstates, molybdates, tellurates, borates or a mixture thereof.

9. The substrate of any one of claims 6-8, wherein the one or more ceramic particles are chosen from BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₈, BaTe₄O₉, Li₃AlB₂O₆, Bi₆B₁₀O₂₄, Bi₄B₂O₉, or a mixture thereof.

10. The substrate of any one of claims 1-9, wherein the ceramic component is in a range of from about 50 wt % to about 95 wt % of the cold-sintered hybrid material.

11. The substrate of any one of claims 1-10, wherein the substrate comprises a plurality of layers of the cold-sintered hybrid material.

12. The substrate of any one of claims 1-11, wherein the relative density is in a range of from about 90% to about 95%.

13. A method of making a substrate, the method comprising:
depositing a first quantity of a mixture on a first backing layer, the mixture comprising:
a polymer component;
a ceramic component; and
a binder;
at least partially drying the first quantity of the mixture to form an at least partially dried first quantity of the mixture on the first backing layer;
removing the first backing layer;
printing at least one of a conductor and an electronic component on the at least partially dried first quantity of the mixture;
contacting the at least partially dried first quantity of the mixture with a solvent; and
sintering the at least partially dried first quantity of the mixture to produce a cold-sintered mixture of the polymer component and the ceramic component,
wherein sintering comprises:
raising a pressure in an environment surrounding the at least partially dried first quantity of the mixture to a range of from about 1 MPa to about 5000 Mpa;
raising a temperature of the at least partially dried first quantity of the mixture in a range of from about 1° C. to about 200° C. above a boiling point of the solvent to cold-sinter the at least partially dried first quantity of the mixture and produce the substrate,
wherein the cold-sintered mixture has a relative density within a range of 80% to 99%.

14. The method of claim 13, further comprising increasing the temperature of the mixture to a temperature sufficient to evaporate a quantity of the binder.

15. The method of any one of claim 13 or 14, further comprising:
cutting the first backing layer to produce a first portion of the mixture and a second portion of the mixture; and
stacking the first portion with respect to the second portion to form a stack, wherein
the first portion forms a first cold-sintered hybrid layer and the second portion forms a second cold-sintered hybrid layer after the stack is sintered.

16. The method of any one of claims 13-15, wherein the at least partially dried mixture is sintered at a temperature in a range of from about 100° C. to about 400° C.

17. The method of any one of claims 13-16, wherein the pressure is in a range of from about 200 Psi to about 3000 Psi.

18. The method of any one of claims 13-17, wherein the polymer component is chosen from a polyimide, a polyamide, a polyester, a polyurethane, a polysulfone, a polyketone, a polyformal, a polycarbonate, a polyether, a poly(p-phenylene oxide), a polyether imide, a polymer having a glass transition temperature greater than 200° C. a copolymer thereof, or a mixture thereof.

19. The method of any one of claims 13-18, wherein the ceramic component includes one or more ceramic particles chosen from BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉ or a mixture thereof.

20. A substrate formed according to a method comprising:
depositing a first quantity of a mixture on a first backing layer, the mixture comprising:
a polymer component;
a ceramic component; and
a binder;
at least partially drying the first quantity of the mixture to form an at least partially dried first quantity of the mixture on the first backing layer;
removing the first backing layer;
printing at least one of a conductor and an electronic component on the at least partially dried first quantity of the mixture;
contacting the at least partially dried first quantity of the mixture with a solvent; and
sintering the at least partially dried first quantity of the mixture of the polymer component and the ceramic component, wherein sintering comprises:
raising a pressure in an environment surrounding the at least partially dried first quantity of the mixture to a range of from about 1 MPa to about 5000 Mpa;
raising a temperature of the at least partially dried first quantity of the mixture in a range of from about 1° C. to about 200° C. above a boiling point of the solvent to cold-sinter the at least partially dried first quantity of the mixture and produce the substrate, wherein
the cold-sintered mixture has a relative density within a range of 80% to 99%
